(19) United States
(12) Patent Application Publication
(10) Pub. No.: US 2025/0144637 A1
(43) Pub. Date: May 8, 2025

(54) ADAPTIVE CRADLE FOR A LIQUID HANDLING SYSTEM

(71) Applicant: Opentrons LabWorks Inc., Long Island City, NY (US)

(72) Inventors: Christopher Yarka, Brooklyn, NY (US); Michael Joseph Kobida, Jr, New York, NY (US)

(73) Assignee: Opentrons LabWorks Inc., Long Island City, NY (US)

(21) Appl. No.: 19/018,852

(22) Filed: Jan. 13, 2025

Related U.S. Application Data
(63) Continuation of application No. PCT/US2024/030123, filed on May 17, 2024.
(60) Provisional application No. 63/503,449, filed on May 19, 2023.

(51) Int. Cl. B01L 9/00; G01N 35/10

(52) U.S. Cl. CPC B01L 9/00; G01N 35/1065

(57) ABSTRACT

A liquid handling system includes a deck housed within an enclosed space of the liquid handling system. The deck may include a plurality of deck slots configured to receive liquid handling modules of different types. A liquid handling module may be coupled to a cradle configured to receive the module. Cradles and modules of a same size as a deck slot may be interchangeably coupled to the deck slot. Each deck slot may include mounting apertures for securely coupling the cradle to the deck. Each mounting aperture may be configured to receive a fastener. The fastener may include a mounting header, a header fastener, and a mounting base removably coupled to the mounting header via the header fastener. The cradle may be securely coupled to the deck slot via inserting and securing the fastener through the mounting aperture.

### CROSS REFERENCE TO RELATED APPLICATIONS

This application claims priority to PCT international No. PCT/US2024/030123, titled “ADAPTIVE CRADLE FOR A LIQUID HANDLING SYSTEM,” filed May 17, 2024, which claims the benefit of priority from U.S. Provisional Patent Application No. 63/503,449, titled “Automated Liquid Handling Systems, Tools, and Calibrations,” filed May 19, 2023, the entirety of which are hereby incorporated by reference.

### TECHNICAL FIELD

The present disclosure relates generally to liquid handling systems. Specifically, the present disclosure relates to systems and methods for coupling, de-coupling, and/or switching between different liquid handling modules that are removably or selectively couplable to a deck of a liquid handling device.

### BACKGROUND

A liquid handling system may include robotic elements, pipettes, a deck, and one or more cradles configured to interact with the robotic elements and/or the pipettes and perform a liquid handling function, lab work, or other processes. In some instances, the one or more cradles may be couplable and the deck and to a receptacle such as a reaction container and/or devices, both the receptable and the device may be used to react liquid solutions dispensed by the pipettes. In one example, the pipettes, receptacles, and/or devices used to react the liquid solutions may be located within an enclosed space in which the reaction may be isolated from any outside environment in order to ensure that no other objects may interrupt the processes of the liquid handling system and/or the reactions taking place within the enclosed space.

In some instances, laboratory work (also referred to as lab work) or other processes may require different receptacles and/or devices that perform different liquid handling, different types of reactions, and/or different lab work functions. In some instances, it may be necessary to switch between or to different receptacles and/or devices to obtain different throughput within the liquid handling system, provide different types of reactions, expedite the processing of a large number of reactions, and/or for other reasons. However, in some liquid handling systems, the liquid handling system may be configured to include only certain fixed receptacles and/or devices or may be configured to include a deck that is configured to accommodate certain receptacles and/or devices. Such liquid handling devices can limit a user to performing a limited number or type of lab work or other processes on. This may significantly reduce throughput of lab work provided by the liquid handling system.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a perspective view of a deck assembly including a number of different cradle devices coupled with the deck assembly and a plurality deck covers.

FIG. 2 illustrates perspective views of coupling a cradle device into the deck assembly of FIG. 1.

FIG. 3 illustrates a perspective view of an empty first cradle for a heater shaker.

FIG. 4 illustrates a perspective view of an assembly of the heater shaker coupled with the first cradle of FIG. 3.

FIG. 5 illustrates a perspective view of an empty second cradle for a temperature module.

FIG. 6 illustrates a perspective view of an assembly of the temperature module couple with the second cradle of FIG. 5.

FIG. 7 illustrates a perspective view of an empty third cradle for a thermocycler.

FIG. 8 illustrates a perspective view of an assembly of the thermocycler coupled with the third cradle of FIG. 7.

FIG. 9 illustrates a computing system diagram illustrating a configuration for a liquid handling system that can be utilized to implement aspects of the technologies disclosed herein.

FIG. 10 illustrates the liquid handling system of FIG. 9, according to an example of the principles described herein.

FIG. 11 illustrates a partially cutaway, perspective view of the liquid handling system of FIG. 9, which includes the assembly of the heater shaker device and the cradle of FIG. 4 coupled to the deck.

FIG. 12 illustrates an alternate partially cutaway, perspective view of the liquid handling system of FIG. 9, which includes the assembly of the heater shaker device and the cradle of FIG. 4 coupled to the deck.

FIG. 13 illustrates a perspective view of an alternative configuration of the deck assembly of FIG. 1 that includes expansion deck covers.

### DESCRIPTION OF EXAMPLE EMBODIMENTS

### Overview

This disclosure describes system and methods of removably or selectively coupling a number of different liquid handling modules to a liquid handling system. The modules (either having the same form factor or different form factors) may be removably or selectively coupled and decoupled to and from a deck within the liquid handling system. The module may include, but are not limited to, a temperature deck, a heater shaker, a thermocycler, a heating device, a cooling device, a vacuum pump, a centrifuge, a liquid handler, a tube handling device, a sealing device, an unsealing device, a magnetic device, and/or other modules and combinations thereof. Having different liquid handling modules may expedite lab work or other processes being performed by allowing a user to install or switch the modules to the liquid handling system without requirement of a specialized operator, a service provider, or a technician. Furthermore, the liquid handling system may be programmed to perform, for a user, the desired lab work or process based on a type of the module(s) coupled to the deck. Alternatively, when initiating the programmed lab work or process, the liquid handling system may instruct the user to couple the appropriate module(s) to the deck and perform the lab work or process after the appropriate modules(s) are coupled to the deck.

Examples described herein provide a liquid handling system (also referred to as a fluid handling system) may include a deck that includes a plurality of deck slots that allows for one or more liquid handling modules to be removably or selectively coupled to the deck. A deck slot of the plurality of deck slots may have different sizes or dimensions. When unoccupied by the module, a slot cover may be coupled to the deck slot. The slot cover may be removed to couple the cradle device to the deck. Multiple adjacent slot covers may be removed to accommodate a module with a size larger than a single deck slot. The slot cover may be secured to the deck slot using a fastening assembly.

A first deck slot of the plurality deck slot may include a first mounting aperture positioned proximate a first longitudinal end and a second mounting aperture positioned proximate a second longitudinal end opposite the first longitudinal end. The first mounting aperture may be configured to receive a first fastener and the second mounting aperture may be configured to receive a second mounting aperture. The first fastener and the second fastener may be configured to securely couple a cradle to a deck slot. Each fastener may include a mounting header, a header fastener, and a mounting based that may be removably coupled to the mounting header via the header fastener.

Each slot cover may include a slot cover receptacle. Each slot cover receptacle may be coupled with a laboratory equipment such as a first laboratory equipment, a second laboratory equipment or a third laboratory equipment. The first laboratory equipment may be a test tube storage container configured to store a plurality of standard test tube, micro test tubes, or the like. Each test tube may contain laboratory materials such as, but not limited to, a biological sample, a chemical sample, a reagent, a washing fluid, a catalyst, a solute, a solvent, and/or the like. The second laboratory equipment may be a fluid handling container such as, but is not limited to, a microplate (also referred to as a well plate), a well reservoir, or the like. The third laboratory equipment may be a pipette tips container. In one example, a configuration of the test tubes within the first laboratory equipment, a configuration of the wells of the second laboratory equipment, and a configuration of the pipette tips within the third laboratory equipment may correspond to a configuration of pipettes being used for a lab work or the configuration of the pipettes being used for the lab work may correspond to a at least the configuration of the wells of the second laboratory equipment. For example, the second laboratory equipment may be a microplate (also referred to as a well plate) containing 96 wells with 12 wells per row along its length (e.g. along the x-axis) with 8 rows, and the configuration of the pipettes may be, but is not limited to, 12 pipettes along the length, 8 pipettes along the width (one for each row), or 96 pipettes covering all 96 wells of the well plate.

Examples described herein provide that each fluid handling module may be coupled to a cradle that is specially designed to receive the fluid handling module. In one example, a cradle configured to be coupled with a temperature changing module may include a vent that allows heated air from the heater shaker to pass to the outside of the fluid handling system. In another example, a cradle configured to be coupled with a thermocycler may be sized to occupy adjacent deck slots. There may also be cradles that are designed to accommodate different types of first party and third-party modules.

Examples described herein provide a user interface (UI) electrically and communicatively coupled with the liquid handling system. A user may interact with the UI to select a lab work for the liquid handling system to perform. In response, the UI may provide instructions for preparing the liquid handling system for operation. The instructions can include prompting the user to couple a module and its corresponding cradle to a deck slot. The instructions can further include prompting the user to couple the module to its corresponding cradle. The instructions may further include installing, removing, or switching one or more pipettes of the liquid handling system. The UI may further require that the user verify at the UI that each step in the instruction has been followed before the following step is provided to the user. The user can further interact with the UI to start the desired lab work once the preparation steps have been completed.

Additionally, the techniques described in this disclosure may be performed as a method and/or by a system having non-transitory computer-readable media storing computer-executable instructions that, when executed by one or more processors, performs the techniques described above.

### EXAMPLE EMBODIMENTS

This disclosure describes a liquid handling system that includes a deck housed within an enclosed space of the liquid handling system. The deck may include a plurality of deck slots configured to receive liquid handling modules of different types. A liquid handling module may be coupled to a cradle configured to receive the module. For example, cradles and modules of a same size as a deck slot may be interchangeably coupled to the deck slot based on requirements of a lab work being performed by the liquid handling system. Each deck slot may include mounting apertures for securely coupling the cradle to the deck. Each mounting aperture may be configured to receive a fastener. The fastener may include a mounting header, a header fastener, and a mounting base removably coupled to the mounting header via the header fastener. The cradle may be securely coupled to the deck slot via inserting and securing the fastener through the mounting aperture.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

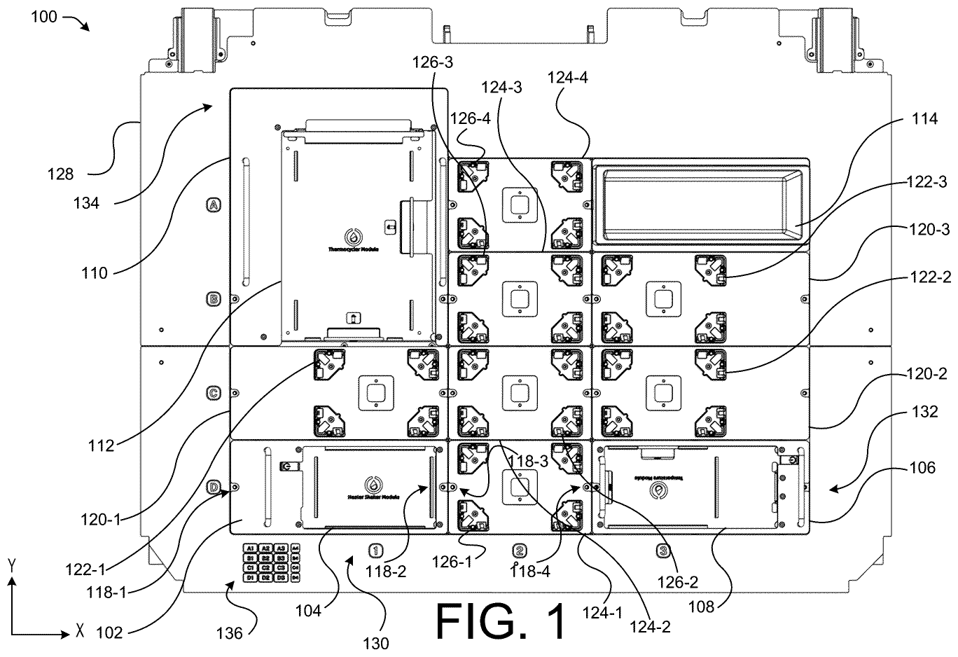

FIG. 1 illustrates a perspective view of a deck assembly 100 for a fluid handling system (also referred to as a liquid handling system), the deck assembly 100 including a number of different cradles devices coupled with a deck 128 and a plurality deck covers. The deck assembly 100 includes a first cradle 102, a first fluid handling module 104, a second cradle 106, a second fluid handling module 108, a third cradle 110, a third fluid handling module 112, a fourth fluid handling fourth fluid handling module 114, a first mounting aperture 118-1, a second mounting aperture 118-2, a third mounting aperture 118-3, a fourth mounting aperture 118-4, a first large slot cover 120-1, a second large slot cover 120-2, a third large slot cover 120-3, a first large slot cover receptacle 122-1, a second large slot cover receptacle 122-2, a third large slot cover receptacle 122-3, a first small slot cover 124-1, a second small slot cover 124-2, a third small slot cover 124-3, a fourth small slot cover 124-4, a first small slot cover receptacle 126-1, a second small slot cover receptacle 126-2, a third small slot cover receptacle 126-3, and a fourth small slot cover receptacle 126-4. In the illustrated example of FIG. 1, the first cradle 102 is coupled with the first fluid handling module 104, the second cradle 106 is coupled with the second fluid handling module 108, and the third cradle 110 is coupled with the third fluid handling module 112. In the illustrated example of FIG. 1, the first cradle 102 coupled with the first fluid handling module 104 form a first combination 130, the second cradle 106 coupled with the second fluid handling module 108 form a second combination 132, and the third cradle 110 coupled with the third fluid handling module 112 form a third combination 134. While a module may be coupled to the deck 128 via a cradle, the module may also directly couple to the deck 128. For example, the fourth fluid handling module 114 is illustrated as being directly coupled with the deck 128.

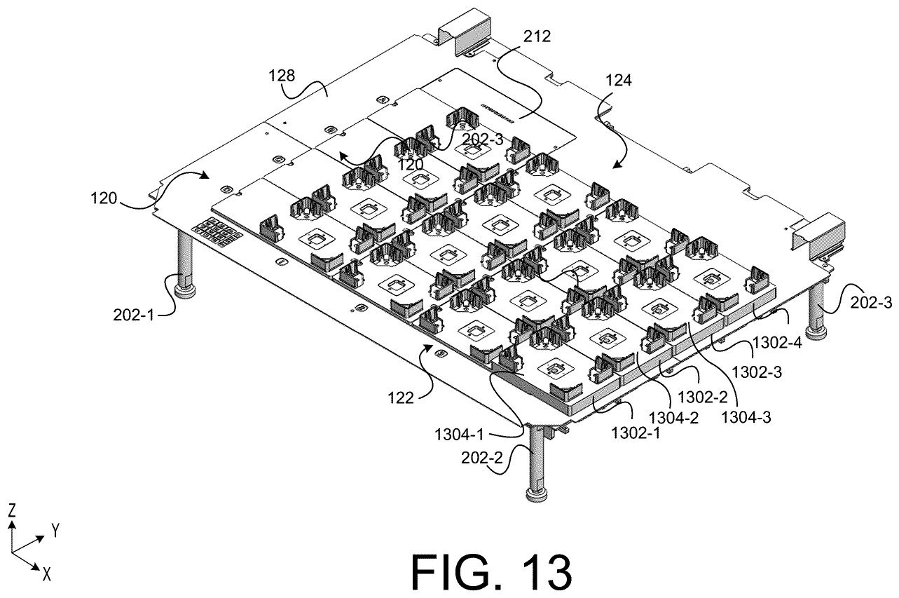

In the illustrated example of FIG. 1, each of the cradles 102, 106, and 110 and each of the large slot covers 120-1 through 120-3 occupies one or more deck slots of the deck 128. In the illustrated example, the deck 128 is also labeled at a first side (e.g. a left side) with the letters A, B, C, and D, each of which indicates a row of deck slots and a second side (e.g., the bottom) is labeled with the numbers 1-3, each of which indicates a column of deck slots. In the illustrated example, the deck 128 further includes a label for each deck slot (e.g., A1, A2, A3, B1, B2, B3, C1, C2, C3, D1, D2, and D3) and a legend 136 which includes the labels for each deck slot A1-D3 and optional expansion cover(s) (e.g., A4, B4, C4, and D4; also referred to as expansion slot(s). The expansion cover(s) are further described in association with FIG. 13, as well as throughout this disclosure.

Each row of deck slots includes a first deck slot, a second deck slot and a third deck slot. Each of the first deck slots, in the illustrated orientation, is a left deck slot (e.g., the left deck slot along row C being covered by the first large slot cover 120-1) having a first length (e.g., along the x-axis). Each of the second deck slots, in the illustrated orientation, is a middle deck slot (e.g., the middle deck slot along row C being covered by the second small slot cover 124-2) having a second length shorter than the first length. Each of the third deck slots, in the illustrated orientation, is a right deck slot (e.g., the deck slot being covered by the second large slot cover 120-2) having the first length. Therefore, each of the first deck slots and the third deck slots can accommodate cradles with longer length than each of the second deck slots. Alternatively, the deck assembly 100 may include a deck with all of its deck slots having a same length and a same width, the first deck slots having the second length, the second and third deck slots having the first length, or the first and second deck slots having the first length and the third slots having the second length.

In the illustrated example FIG. 1, deck slots that are unoccupied by a cradle are covered by an appropriately sized slot cover. Each slot cover may include a slot cover receptacle such as the large slot cover receptacles 122-1 through 122-3 and 126-1 through 126-3. In one example, each slot cover receptacle may be coupled with a laboratory equipment. In one example, a first laboratory equipment may be coupled with the first large slot cover receptacle 122-1, a second laboratory equipment may be coupled with the first small slot cover receptacle 126-1, and a third laboratory equipment may be coupled with the second large slot cover receptacle 122-2. The first laboratory equipment may be a test tube storage container configured to store a plurality of standard test tube, micro test tubes, or the like. Each test tube may contain laboratory materials such as, but not limited to, a biological sample, a chemical sample, a reagent, a washing fluid, a catalyst, a solute, a solvent, and/or the like. The second laboratory equipment may be a fluid handling container such as, but is not limited to, a well plate, a well reservoir, or the like. The third laboratory equipment may be a pipette tips container. In one example, a configuration of the test tubes within the first laboratory equipment, a configuration of the wells of the second laboratory equipment, and a configuration of the pipette tips within the third laboratory equipment may correspond to a configuration of pipettes being used for a lab work or the configuration of the pipettes being used for the lab work may correspond to a at least the configuration of the wells of the second laboratory equipment. For example, the second laboratory equipment may be a microplate (also referred to as a well plate) containing 96 wells with 12 wells per row along its length (e.g. along the x-axis) with 8 rows, and the configuration of the pipettes may be, but is not limited to, 12 pipettes along the length, 8 pipettes along the width (one for each row), or 96 pipettes covering all 96 wells of the well plate.

In the illustrated example, slot covers 120-1 through 120-3 and 122-1 through 122-3 each contain a single slot cover receptacle, where a size of each slot cover receptacle may be approximately a size of the first small slot cover receptacle 126-1. Alternatively, the size of the slot cover receptacles 122-1 through 122-3 may approximate a size of the slot cover receptacles 122-1-122-3 or the slot cover receptacles 122-1 through 122-3 may include 2 slot cover receptacles (e.g., a second cover receptacle may occupy an empty portion of the first large slot cover 120-1).

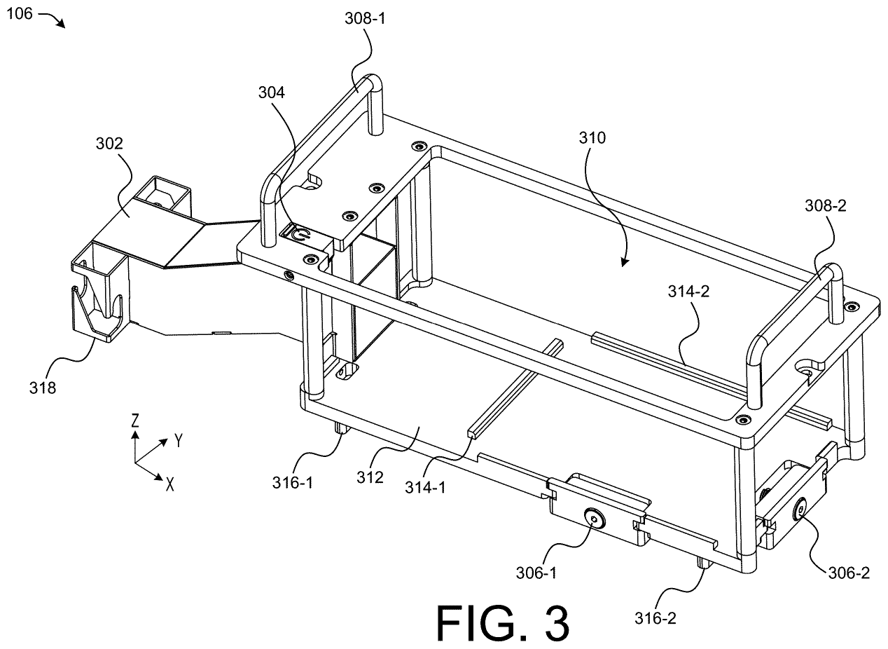

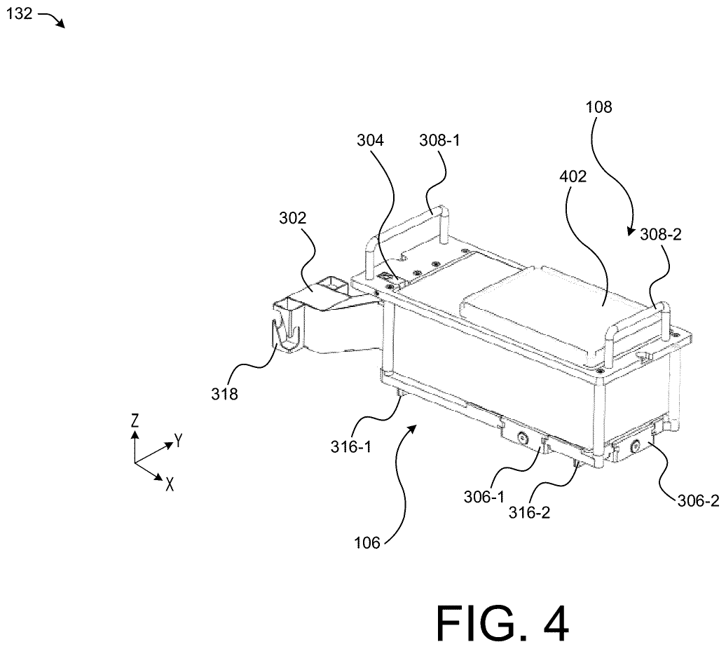

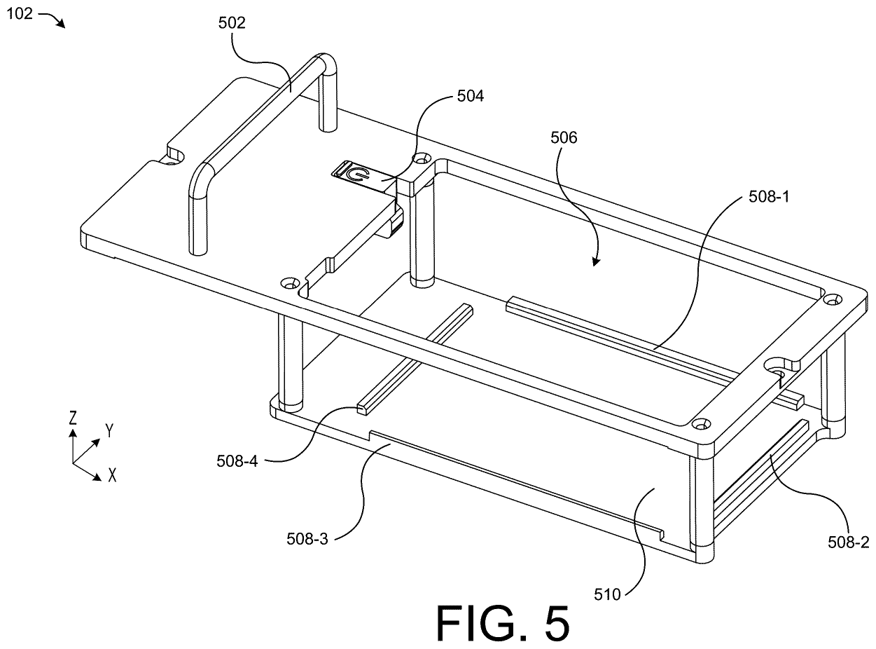

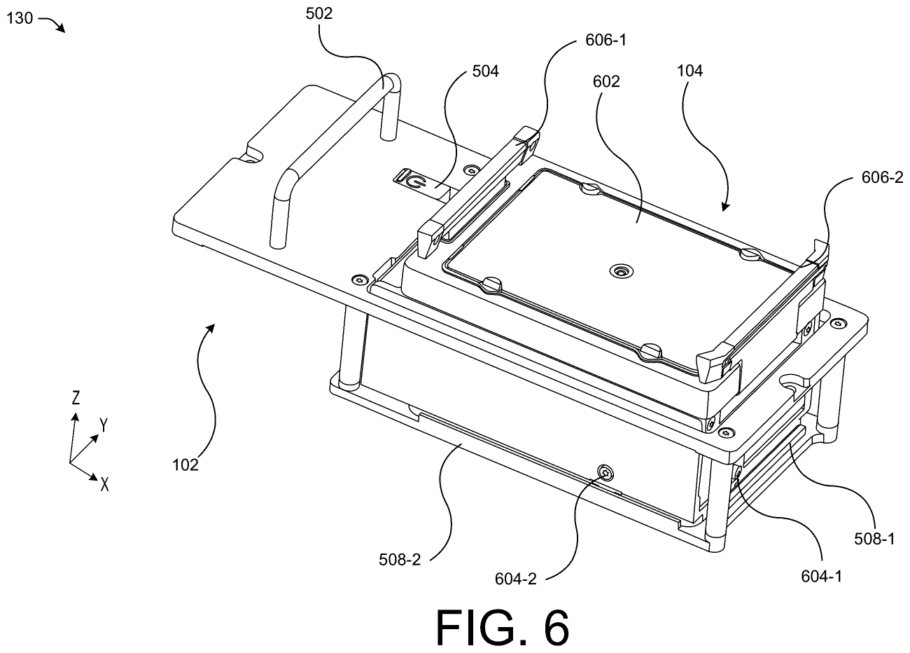

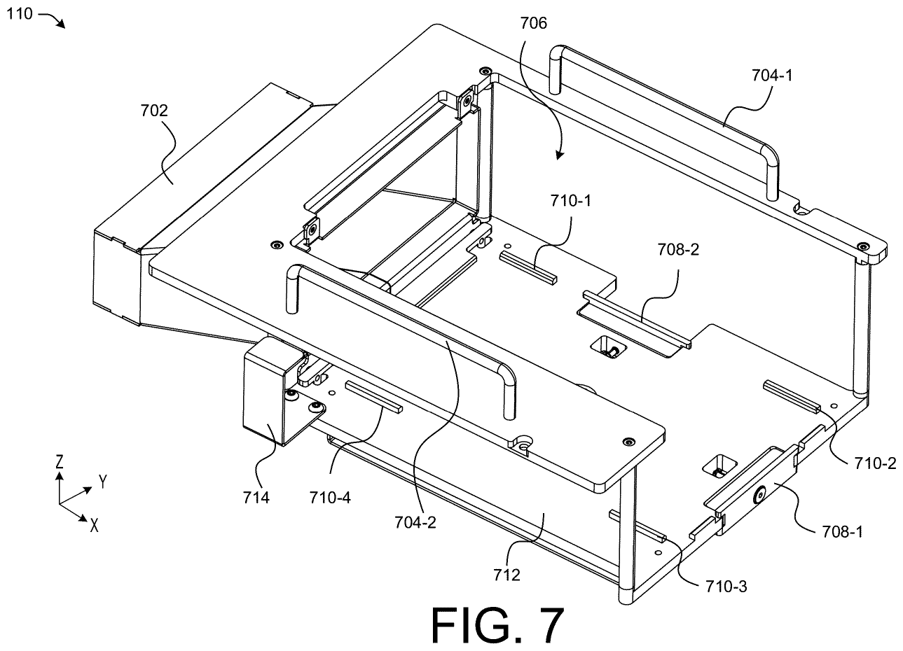

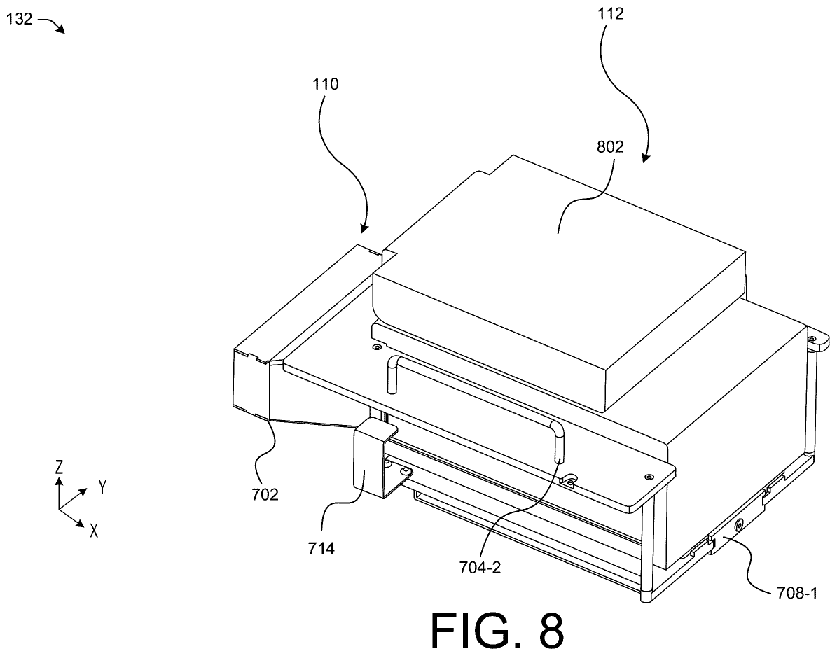

In the illustrated example, the first fluid handling module 104 is a heater shaker. Additional details with respect to the first cradle 102 and the first fluid handling module are discussed in association with FIGS. 3 and 4, as well as throughout this disclosure. In the illustrated example, the second fluid handling module 108 is a temperature module. Furthermore, the first cradle 102, the second cradle 106, and slot covers 120-1 through 120-3 may have a same size. to While the FIG. 1 illustrates an example configuration, the first cradle 102 and the second cradle 106 may be coupled to any deck slot of the deck 128 that has the same size as the first cradle 102 and the second cradle 106. For example, the first cradle 102 and the second cradle 106 may swap deck slots with each other. The first cradle 102 or the second cradle 106 may be coupled to any of the deck slots occupied by the deck covers 120-1 through 120-3. Additional details with respect to the second cradle 106 and the second fluid handling module 108 are discussed in association with FIGS. 5 and 6, as well as throughout this disclosure. In the illustrated example, the third fluid handling module 112 is a thermocycler module. Additional details with respect to the third cradle 110 and the third fluid handling module 112 are discussed in association with FIGS. 7 and 8, as well as throughout this disclosure.

As illustrated in FIG. 1, a cradle and its corresponding module (e.g., the third cradle 110 and the third fluid handling module 112) may be required to occupying more than a single deck slot. In such a scenario, additional adjacent deck slot(s) may be used accommodate the cradle (e.g., removing adjacent slot covers). The deck (e.g., as illustrated in the deck 128) may include one or more extra deck slots in addition to the rows A-D. In an example, the extra deck slot(s) may be configured to accommodate a cradle that requires three or more deck slots without needing the cradle to use more than two of the deck slots from the rows A-D and/or the columns 1-3 as illustrated by the third cradle 110.

As illustrated in FIG. 1, each deck slot can include a first mounting aperture at a first longitudinal end and a second mounting aperture at a second longitudinal end opposite the first longitudinal end (e.g., the first mounting aperture 118-1, the second mounting aperture 118-2, the third mounting aperture 118-3, and the fourth mounting aperture 118-4). As a first example, the first mounting aperture 118-1 may be configured to accommodate a first header fastener and the second mounting aperture 118-2 may be configured to accommodate a second header fastener. The first header fastener may be inserted through the first mounting aperture 118-1 and removably coupled to a first mounting header and a first mounting base to secure a first end of the first cradle 102 to the deck 128. A second header fastener may be inserted through the second mounting aperture 118-2 and removably coupled to a second mounting header and a second mounting base to secure a second end of the first cradle 102 to the deck 128. Similarly, as a second example, a third header fastener may be inserted through the third mounting aperture 118-3 and removably coupled to a third mounting header and a third mounting base to secure a first end of the first small slot cover 124-1 to the deck 128, and a fourth header fastener may be inserted through the fourth mounting aperture 118-4 and removably coupled to a fourth mounting header and a fourth mounting based to secure a second end of the first small slot cover 124-1 to the deck 128.

Each of the other slot cover and cradles may also be secured to the deck 128 similarly as described in the examples of securing the first cradle 102 and the first small slot cover 124-1 to the deck 128. Furthermore, each mounting aperture may be a threaded aperture where the header fastener may be twisted through the threaded aperture. Additionally or alternatively, the header fastener may include a captive screw. Alternatively, the slot covers and cradles may be secured to the deck 128 using clamps, magnets, or other standard mounting solutions such as snapping into place which may secure the covers and cradles to the deck 128.

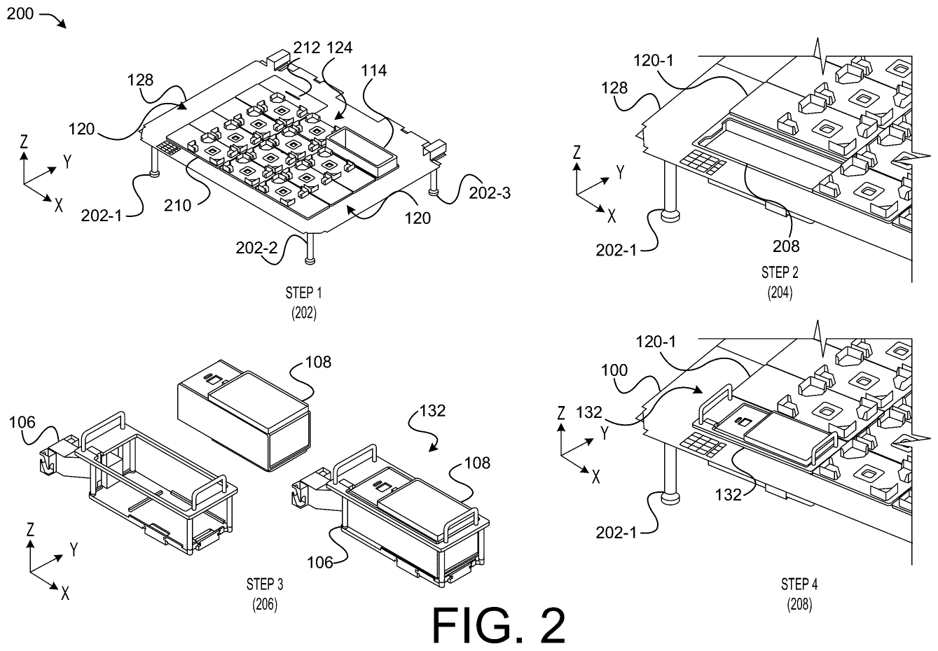

FIG. 2 illustrates perspective views 200 of a process of coupling a fluid handling module to a cradle and the cradle to the deck assembly of FIG. 1. The process is illustrated as four example steps. FIG. 2 also illustrates an alternative configuration for coupling second cradle 106 to the deck 128. In FIG. 2, the second cradle 106 is illustrated as being coupled to the deck slot occupied by the first cradle 102 in FIG. 1.

At step 1, FIG. 2 illustrate the deck 128 of FIG. 1 that is unoccupied by any cradle. The unoccupied deck 128 is covered by large slot covers 120 and the small slot covers 124. An extra slot cover 212 also covers an extra deck slot. The deck 128 also includes a first leg 202-1 positioned proximate a first corner of the deck 128, a second leg 202-2 positioned proximate a second corner of the deck 128, and a third leg 202-3 positioned proximate a third corner of the deck 128. The deck 128 may also include a fourth leg positioned proximate a fourth corner of the deck 128, the fourth corner a corner that is opposite the first corner and the third corner. The first leg 202-1, the second leg 202-2, the third leg 202-3 and the fourth leg may be used mount and/or secure the deck 128 to the fluid handling system. In an example, the first leg 202-1, the second leg 202-2, the third leg 202-3, and the fourth leg may be utilized as legs of the fluid handling system.

At step 2, the process may include opening a deck slot 208 positioned at the first corner of the deck 128 and adjacent to the first large slot cover 120-1 by removing the large slot cover 120 positioned at the first corner and covering the deck slot 208. As illustrated, the opened deck slot opens a space below the deck 128 where a cradle may be inserted into for coupling to the deck 128. Opening the large slot cover 120 may include first removing a first mounting fastener and a second mounting fastener from the slot cover as described in association with FIG. 1.

At step 3, the process may include coupling the module to the cradle. FIG. 2 illustrates coupling the second fluid handling module 108 to the second cradle 106 to form the second combination 132 of the second cradle 106 and the second fluid handling module 108. The second cradle 106 may include one or more screws, clamps, magnets, and/or other mounting solutions which may secure the second fluid handling module 108 to the second cradle 106. In the illustrated example, the second fluid handling module 108 is secured to the second cradle 106 using at least one clamp. Furthermore, in the illustrated example, the second cradle 106 is designed specifically for the second fluid handling module 108. Alternatively, the second cradle may be designed to accommodate a number of modules including first party and third-party modules.

At step 4, the process can include inserting the combination 132 into the deck slot 208 to couple the combination 132 to the deck 128. Securing the combination 132 to the deck slot 208 may include inserting the first mounting fastener and the second mounting fastener as described in association with FIG. 1.

FIG. 3 illustrates a perspective view of an example second cradle 106 for a temperature module. The second cradle 106 includes a duct 302 (also referred to as a vent), a button 304, a first clamp 306-1, a second clamp 306-2, a first handle 308-1, a second handle 308-2, a compartment 310, a floor 312, a first bumper 314-1, a second bumper 314-2, a first feet 316-1, a second feet 316-2, and a slot 318. The duct 302 may allow air heated by the temperature module to pass through. The duct 302 may further allow the air passing through the temperature module to pass beyond the scope of the deck 128, and thus making sure that a temperature underneath the deck 128 and a temperature at the deck 128 are unaffected by the use of the temperature module. The button 304 may be configured to be pressed by a robotic component or a pipette component of the fluid handling system. The button 304 may be electrically and/or mechanically coupled to the second cradle 106 and/or the temperature module. For example, the button 304 may be pressed by a robotic arm and/or a gripper arm or a pipette tip of the fluid handling system. In one example, pressing the button 304 may activate or deactivate the temperature module. Pressing the button 304 to activate the temperature module may cause the temperature module to increase in temperature. The first clamp 306-1 and second clamp 306-2 may be in an unclamped mode when the second cradle 106 is empty and may be in a clamped mode when the temperature module is coupled to the second cradle 106 to secure the temperature module within compartment 310. The first handle 308-1 and second handle 308-2 may allow for easier coupling of the second cradle 106 to the deck 128 by having a user or robotic arms and/or gripper arms to grab each handle to couple or decouple the first cradle from the deck 128. The first bumper 314-1 and second bumper 314-2 on the floor 312 may work together with the first clamp 306-1 and second clamp 306-2 to secure the temperature module within the compartment 310 and prevent the temperature module from moving once secured. When decoupled from the deck 128, the second cradle 106 may be placed on a surface using the first feet 316-1 and second feet 316-2.

FIG. 4 illustrates a perspective view of an example of the second combination 132 of the second cradle 106 and the second fluid handling module 108 of FIG. 1. The second fluid handling module 108 is the temperature module described in association with FIGS. 1 and 3. The second fluid handling module 108 may be configured to hold samples and/or reagents at a temperature within a range of temperatures. The range of temperature may be between 4 degrees Celsius and 95 degrees Celsius. The second fluid handling module 108 may use a thermoelectric component (e.g., a Peltier unit) to maintain the temperature. The first clamp 306-1 and second clamp 306-2 may include threaded fasteners such as captive screws to secure the second fluid handling module 108 to the second cradle 106. When coupled to the second cradle 106 and coupled to the deck 128, heat generated by the first fluid handling module 104 may be removed from the temperature module through the duct 302 of the second cradle 106. The second fluid handling module 108 may be used for an experiment and/or a process such as, but is not limited to, cell lysis, restriction digestion, heat shock transformation, and/or DNA isolation. Laboratory equipment such as a well plate and a well reservoir may be removably coupled to the second fluid handling module 108 at a second module deck 402 to perform the experiment and/or process. When coupled to the second cradle 106 (e.g., in the combination 132), the second fluid handling module 108 may be electrically and/or communicatively coupled to the second cradle 106 such that when the button 304 is pressed, the second fluid handling module 108 is activated or deactivate. In addition, when in the combination 132, an electric wire or cable for powering the second fluid handling module 108 may be inserted through the slot 318 for an organized management of the wire or cable. The combination 132 may be coupled to the deck 128 of FIG. 1 using the process described in association with FIG. 2.

FIG. 5 illustrates a perspective view of an example first cradle for a heater shaker module. In the illustrated example, the example first cradle may be an example of the first cradle 102 of FIG. 1. The heater shaker module may be an example of the first fluid handling module 104. The first cradle 102 includes a handle 502, a button 504, a compartment 506, a first bumper 508-1, a second bumper 508-2, a third bumper 508-3, a fourth bumper 508-4, and a floor 510. The handles 502 may allow for easier coupling of the first cradle 102 to the deck 128 by having a user or a robotic arm and/or a gripper arm of the fluid handling system to grab handle 502 to couple or decouple the first cradle from the deck 128. A function of the button 504 may correspond to the function of the button 304 of FIG. 3 and may be mechanically and/or electrically coupled to the first cradle 102 and/or the heater shaker module such that when pressed by the user or by the robotic arm and/or the gripper arm, the button 504 may activate or deactivate the heater shaker module. The heater shaker module may be coupled to the first cradle 102 within the compartment 506. The bumpers 508-1 through 508-4 on the floor 510 may be configured to dampen, limit the magnitude of its shaking, and keep the heater shaker module within the compartment 506 during its shaking operation.

FIG. 6 illustrates a perspective view of an example of the first combination 130 of the first cradle 102 and the first fluid handling module 104. In the illustrated example, the first fluid handling module 104 is the heater shaker module described in association with FIGS. 1 and 5. The first fluid handling module 104 may be used to automate heating and orbital shaking of sample(s). Examples of an experiment or process that may be performed by the first fluid handling module 104 may be, but are not limited to, nucleic acid extraction from blood, tissue, cultured cells, environmental samples, an immunoassay, or another processes that requires heating and agitation. A heating component of the first fluid handling module 104 can heat samples up to 95 degrees Celsius using a combination of a resistive element and a temperature sensor to reach and maintain a target temperature. A shaking component of the first fluid handling module 104 may agitate sample(s) using orbital shaking between a range of 200 rpm and 3000 rpm. The first fluid handling module 104 may be secured to the first cradle 102 using a first fastener 604-1 and a second fastener 604-2. In one example, the first fastener 604-1 and second fastener 604-2 may be threaded and/or captive screws. In one example, the first fastener 604-1 and second fastener 604-2 may secure the first fluid handling module 104 to bumpers 508-1 and 508-2, respectively. Additional fasteners are contemplated to secure the first fluid handling module 104 to the bumpers 508-3 and 508-4 as well. The first fluid handling module 104 may further include a receptacle 602 configured to accept a laboratory equipment such as, but not limited to, a well plate or a well reservoir. The first fluid handling module 104 may additionally include a first clamp 606-1 and a second clamp 606-2 configured to secure the laboratory equipment to the receptacle 602.

FIG. 7 illustrates a perspective view of an example of the third cradle 110. In the illustrated example, the third cradle 110 is configured to couple to a thermocycler. The third cradle 110 includes a duct 702, a first handle 704-1, a second handle 704-2, a compartment 706, a first clamp 708-1, a second clamp 708-2, a first bumper 710-1, a second bumper 710-2, a third bumper 710-3, a fourth bumper 710-4, a floor 712, and a slot 714. Similar to the duct 302 of FIG. 3, the duct 702 may be used to remove heat from the thermocycler. The first handle 704-1 and second handle 704-2 may assist in a user or robotic arms and/or gripper arms of the liquid handling system in coupling to or removing the third cradle 110 from the deck 128. The first clamp 708-1 and second clamp 708-2 may secure the thermocycler within the compartment 706 along the floor 712 and the bumpers 710-1 through 710-4.

FIG. 8 illustrates a perspective of an example of the third combination 134 of the third cradle 110 and the third fluid handling module 112. In the illustrated example, the third fluid handling module 112 is the thermocycler described in association with FIGS. 1 and 7. The third module may be used in processes involving a polymerase chain reaction (PCR) such as, but not limited to, amplifying DNA within a sample, next generation sequencing (NGS) library preparation, DNA assembly, mutagenesis, genotyping, and/or other PCR related processes. The first clamp 708-1 and second clamp 708-2 may include threaded fasteners such as a regular screw or a captive screw to secure the third fluid handling module 112 to the third cradle 110. The third fluid handling module 112 may include a cover 802 covering a compartment configured to receive a laboratory equipment such as a well plate or a well reservoir. The cover 802 may open to permit pipetting of fluid (e.g., samples, reagents, and/or the like) into the laboratory equipment within the compartment. The cover 802 may close after the pipetting finishes, and/or when the third fluid handling module 112 is in operation to heat and cool the fluid within the laboratory equipment. During operation, the third fluid handling module 112 may heat and cool the fluid within the laboratory equipment multiple times.

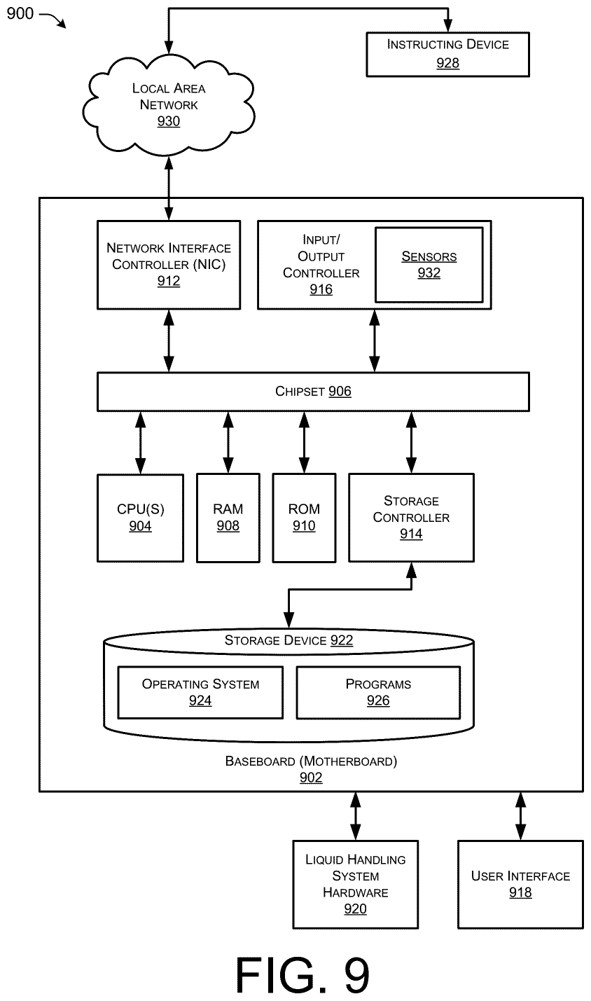

FIG. 9 illustrates a computing system diagram illustrating a configuration for a liquid handling system 900 that may be utilized to implement aspects of the technologies disclosed herein. The liquid handling system 900 may include a baseboard (also referred to as a motherboard) 902, which may be a printed circuit board to which a plurality of components or devices may be connected by way of a system bus or other electrical communication paths. In one example, one or more central processing units (CPUs) 904 operating in conjunction with a chipset 906 may be connected to the baseboard 902. The CPUs 904 may be programmable processors configured to perform arithmetic and logical operations necessary for the operation of the liquid handling system 900.

The CPUs 904 perform operations by transitioning from one discrete, physical state to the next through the manipulation of switching elements that differentiate between and change these states. Switching elements may include electronic circuits that maintain one of two binary states, such as flip-flops, and electronic circuits that provide an output state based on the logical combination of the states of one or more other switching elements, such as logic gates. These switching elements may be combined to create more complex logic circuits, including registers, adders-subtractors, arithmetic logic units, floating-point units, and the like.

The chipset 906 provides an interface between the CPUs 904 and other components and devices on or connected to the baseboard 902. The chipset 906 may provide an interface to a Random Access Memory (RAM) (also referred to as a memory) 908, used as a main memory for the liquid handling system 900. The chipset 906 may further provide an interface to one or more computer-readable storage medium such as a read-only memory (ROM) 910 or non-volatile RAM (“NVRAM”) for storing basic routines that assists in starting up the liquid handling system 900 and to transfer information between the various components and devices. The ROM 910 or NVRAM may also store other software components necessary for the operation of the liquid handling system 900 in accordance with the configurations described herein.

The liquid handling system 900 may operate in a networked environment using logical connections to remote computing devices and computer systems through a network, such as the network 930. Each component of the liquid handling system 900 may be communicatively connected to each other via the network 930. The chipset 906 may include functionality for providing network connectivity through a network interface controller (NIC) 912, such as a gigabit Ethernet adapter or a wireless network adapter. The NIC 912 is capable of connecting the liquid handling system 900 to other computing devices over the network 930. It should be appreciated that multiple NICs 912 may be present in the liquid handling system 900, connecting the computer to other types of networks and remote computer systems. The liquid handling system 900 may be connected to an instructing device 928. The instructing device 928 may include any computing device apart from the computing elements of the liquid handling system 900 and may be used to provide instructions and/or programming to the liquid handling system 900. In one example, the instructing device 928 may be included “as a service” (aaS) in which a product use is offered as a service (e.g., as a subscription-based service) rather than as an artifact owned and maintained by the user. The instructing device 928 may further be a user device used by a user of the liquid handling system 900 to provide operating instructions to the liquid handling system 900 remotely.

Although the elements described in connection with FIG. 9 are depicted as being connected directly or indirectly via, for example, the LAN 930, the elements may be included entirely in the liquid handling system 900 or dispersed among any number of separate devices and across any number of computing networks. For example, the instructing device 928 may be located directly within the liquid handling system 900 as opposed to connected through the LAN 930 as depicted in FIG. 9.

The liquid handling system 900 may include or be electrically, mechanically, and/or or communicatively connected to a storage device 922 that provides non-volatile storage for the liquid handling system 900. The storage device 922 may store an operating system 924, programs 926, and other data. The storage device 922 may be connected to the liquid handling system 900 through a storage controller 914 connected to the chipset 906. The storage device 922 may include of one or more physical storage units. Examples of the physical storage units may be, but are not limited to, hard disk drives (e.g., using a magnetic disk), solid state drives, optical disks, and/or the like. The storage controller 914 may interface with the physical storage units through a serial attached SCSI (SAS) interface, a serial advanced technology attachment (SATA) interface, a fiber channel (FC) interface, a nonvolatile memory express (NVMe) interface, or other type of interface for physically connecting and transferring data between the physical storage units and other components of the liquid handling system 900.

The liquid handling system 900 may store data on the storage device 922 by transforming the physical state of the physical storage units to reflect the information being stored. The specific transformation of physical state may depend on various factors, in different embodiments of this description. Examples of such factors may include, but are not limited to, the technology used to implement the physical storage units, whether the storage device 922 is characterized as primary or secondary storage, and the like.

For example, the liquid handling system 900 may store information to the storage device 922 by issuing instructions through the storage controller 914 to alter a magnetic characteristic of a particular location within a hard disk drive unit, a reflective or refractive characteristic of a particular location in an optical disk, or an electrical characteristic of a particular capacitor, transistor, or other discrete component in a solid state storage drive. Other transformations of physical media are possible without departing from the scope and spirit of the present description, with the foregoing examples provided only to facilitate this description. The liquid handling system 900 may further read information from the storage device 922 by detecting the physical states or characteristics of one or more particular locations within the physical storage units.

In addition to the storage device 922 described above, the liquid handling system 900 may have access to other computer-readable storage media to store and retrieve information, such as program modules, data structures, or other data. It should be appreciated by those skilled in the art that computer-readable storage media is any available media that provides for the non-transitory storage of data and that may be accessed by the liquid handling system 900. In one example, the operations performed by the liquid handling system 900, and or any components included therein, may be supported by one or more devices similar to liquid handling system 900. Stated otherwise, some or all of the operations performed by the liquid handling system 900, and/or any components included therein, may be performed by one or more computing devices operating in a cloud-based arrangement.

By way of example, and not limitation, the computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 922 may store an operating system 924 utilized to control the operation of the liquid handling system 900. According to one embodiment, the operating system 924 may include the LINUX operating system. According to another example, the operating system may include the WINDOWS® operating system or its SERVER variant from MICROSOFT Corporation of Redmond, Washington.

According to further examples, the operating system 924 may include the UNIX operating system or one of its variants. It should be appreciated that other operating systems may also be utilized. The storage device 922 may store other system or application programs and data utilized by the liquid handling system 900.

In one example, the storage device 922 or other computer-readable storage media is encoded with computer-executable instructions which, when loaded into the liquid handling system 900, transform the computer from a general-purpose computing system into a special-purpose computer capable of implementing the embodiments described herein. These computer-executable instructions transform the liquid handling system 900 by specifying how the CPUs 904 transition between states, as described above. According to one example, the liquid handling system 900 has access to computer-readable storage media storing computer-executable instructions which, when executed by the liquid handling system 900, perform the various processes described herein. The liquid handling system 900 may also include computer-readable storage media having instructions stored thereupon for performing any of the other computer-implemented operations described herein.

The liquid handling system 900 may also include one or more input/output controllers 916 for receiving and processing input from a number of input devices, such as a user interface (UI) 918 on a touch screen, or the UI 918 on a non-touch screen and a keyboard, a mouse, a touchpad, an electronic stylus, a remote device (e.g., a remote computing device) communicatively coupled to the liquid handling system 900, or other type of input device configured to interface with the UI 918. Similarly, an input/output controller 916 may provide output to a display such as, but not limited to a computer monitor, a flat panel display, a built-in touch screen, or a digital projector, a printer, or other type of output device. It will be appreciated that the liquid handling system 900 might not include all of the components shown in FIG. 9, may include other components that are not explicitly shown in FIG. 9, or might utilize an architecture completely different than that shown in FIG. 9.

The UI 918 may include any user input and/or output device as described above in connection with the devices associated with the input/output controllers 916. The UI 918 may include, for example, a tactile UI (e.g., touch), a visual UI (e.g., sight), an auditory UI (e.g., sound), other types of UI devices, and combinations thereof. The UI 918 may be utilized by the user to receive information and instruction from the liquid handling system 900 as to how to operate the liquid handling system 900 including, for example, switching between pipettes that are selectively couplable to the movable stage and/or switching between cradle and module combinations as illustrated in association with FIGS. 1 and 2. As this is one aspect of the present systems and methods, a process by which the user may interface with the UI 918 will now be described.

The UI 918 may display at least one selectable option which the user may select and begin a series of prompts and/or verifications displayed on the UI 918 to achieve a process of coupling the first combination 130 of the first cradle 102 and the first fluid handling module 104 to the deck 128. The selectable option may include presenting one or more a lab work for the user to select. Upon selection the lab work using the UI 918, the UI 918 may present a first prompt series of instructions and verifications to complete the coupling process. The UI 918 may also, based on the selected lab work, a second prompt series of instructions and verifications to switch between pipettes based on the lab work. The liquid handling system 900 may execute at least one of the operating system 924 and the programs 926 to present the prompt series on the UI 918. Further, the input/output controller 916 may assist in communicatively interfacing the UI 918 with the chipset 906 and the storage device 922 in order for the operating system 924 and the programs 926 to display the instructions and verifications associated with the prompt series on the UI 918 and interpret any input from the user via the UI 918.

In one example, the first and second prompt series of instructions and verifications may include text, images, video, selectable buttons, other instructional representations, and combinations thereof that may be displayed on the UI 918. Additionally or alternatively, the instructions and verifications may be presented to the user on the instructing device 928. The user may utilize these instructional representations to receive instruction from and provide input to the liquid handling system 900. Therefore, any interactions between a user and the liquid handling system 900 may be provided via the UI 918 and/or the instructing device 928 and in manner in which the user may easily understand how to perform the cradle and module coupling process and/or the pipette switching process. For example, to install the second cradle 106 and the second fluid handling module 108 to the deck 128, the UI 918 may present instructions in visual form similar to those illustrated in FIG. 2 in still picture or video form. The instructions may further include audio instructions.

In one example, the prompt series of instructions and verifications may also include prompts to the user to verify that one or more actions have been taken by the user. Such a user verification allows for the prompt series of instructions to continue to a next step or instruction. Further, in one example, a redundant system may be present within the liquid handling system 900 in connection with the UI 918 in the form of a one or more sensors 932 included with the input/output controllers 916 that are able to detect one or more states associated with the liquid handling system 900 and brought about by user action. For example, upon the user indicating via the UI 918 that the second cradle 106 and the second fluid handling module 108 have been coupled to a deck slot designated by the UI 918, the redundant system can automatically utilize the sensors 932 to verify that the second fluid handling module 108 and the second cradle 106 was coupled to a deck slot designated by the UI 918.

To begin the process of coupling the first cradle 102 and the second fluid handling module 108, at a first step, the user may be prompted by the UI 918 to locate the designated deck slot. For example, the UI 918 may prompt the user to locate the deck slot 208. The UI 918 may further prompt the user to confirm whether the slot covers 210 occupies the deck slot 208. Alternatively, the redundant system can use the sensors 932 to automatically determine whether the slot covers 210 is occupying the deck slot 208. The redundant device may determine that the slot cover 210 is occupying the deck slot 208 using a visual sensor (e.g., a camera) of the sensors 932 and/or determines based on sensor data from the other sensor(s) of sensors 932 indicating an identifier associated with the slot cover 210 such as a barcode, radio frequency identification (RFID), capacitance associated with the deck slot 208, the slot covers 210, or any other modules and/or cradles that occupy the deck slot 208, or other identifier.

In a scenario where the user is performing the verification, the user can interact with the UI 918 to select whether the slot cover 210 is occupying the deck slot 208. Upon verifying that the slot cover 210 is occupying the deck slot 208, at a second step, the user may be prompted via the UI 918 to disengage with the first fastener occupying the first mounting aperture 118-1 and disengage the second fastener occupying the second mounting aperture 118-2. By doing so, the slot cover 210 may be separated from the deck slot 208. Alternatively, a robotic arm and/or a gripper arm associated with the liquid handling system 900 can automatically disengage the fasteners and remove the slot cover 210.

The first fastener can include a first header fastener, a first mounting header, and a first mounting base. The first mounting base may be removably coupled to the first mounting header via the first header fastener. The second fastener can include a second header fastener, a second mounting header and a second mounting base. The second mounting based may be removably coupled to the second mounting header via the second header fastener. The mounting apertures 118-1 and 118-2 may include threaded apertures. Disengaging the first fastener may include loosening the first fastener along the threaded aperture.

After removing the slot cover 210, the user may interact with the UI 918 to indicate that the slot cover 210 was removed. The UI 918 may prompt the user to verify that the slot cover 210 was removed, and user may interact with the UI 918 to perform the verification. Additionally or alternatively, the redundant device may use the sensors 932 to automatically verify that the slot cover 210 was removed. For example, the redundant device may use the visual sensor of the sensors 932 to determine that the deck slot 208 is empty or unoccupied.

Once the deck slot 208 is verified to be empty or unoccupied, the UI 918 may instruct the user to couple the second fluid handling module 108 with the second cradle 106. This instruction may correspond to step 3 of FIG. 2. The instructions may prompt the user to first insert the second fluid handling module 108 into the compartment 310. For this step, the instructions present a verification asking the user to verify that a vent associated with the second fluid handling module 108 is coupled to the duct 302 such that heat may exit from the vent to an outside via the duct 302. Once coupled, the instructions may then prompt the user to secure the second fluid handling module 108 with the second cradle 106 by engaging the first clamp 306-1 and second clamp 306-2 with the second fluid handling module 108. The first clamp 306-1 and second clamp 306-2 may be engaged by pressing the clamps into the second fluid handling module 108. Alternatively, the first clamp 306-1 and second clamp 306-2 may include threaded fasteners such as captured screws, when tightened, may engage the first clamp 306-1 and second clamp 306-2 with the second fluid handling module 108. Once secured, the user may interact with the UI 918 to verify that the second fluid handling module 108 is secured within the second cradle 106. Additionally or alternatively, the redundant device may use the sensors 932 to automatically verify the coupling between the second cradle 106 and the second fluid handling module 108. Alternative to having a user couple the second fluid handling module 108 to the second cradle 106, the robotic arm and/or the gripper arm of the liquid handling system 900 can couple the second fluid handling module 108 and the second cradle 106.

Once the second step is verified to be complete, the UI 918 can instruct the user, as a third step, to insert the combination 132 into the open deck slot 208. The UI 918 can further instruct the user to make sure that the end of the second cradle 106 with the duct 302 is oriented toward an outside of the liquid handling system 900. Once, inserted, the UI 918 can instruct the user to secure the second cradle 106 to the deck slot 208 by inserting and tightening the fasteners to the mounting apertures 118-1 and 118-2. Once secured, the UI 918 can prompt the user to verify that the cradle 106 is securely coupled with the deck 128. The user can interact with the UI 918 to verify. Additionally or alternatively, the redundant device can use the sensors 932 to automatically verify that the second cradle 106 was securely coupled to the deck 128. For example, the redundant device can use the visual sensor of sensor 932 to make the verification or determine, using sensors 932, an identifier associated the second cradle 106 or the second fluid handling module 108, and determine, based on the identifier, that at least the second cradle 106 is coupled to the deck 128. As an alternative to having the user couple the second cradle 106 to the deck slot 208, robotic arms and/or gripper arms of the liquid handling system 900 can lift the second cradle 106 by way of the first handle 308-1 and second handle 308-2 into the open deck slot 208 and tighten the fasteners.

Upon completing the third step, as a fourth step, the UI 918 can provide an instruction to the user to couple a laboratory equipment to the second fluid handling module 108. The instruction can include instructing the user on the type of laboratory equipment. Coupling the laboratory equipment is described in association with FIG. 4.

The UI 918 may further provide instructions to the user to couple additional modules and additional cradles to the deck 128, as necessary. For example, the UI 918 can provide instructions to couple the first cradle 102 and the third cradle 110 to the deck 128 along with the relevant laboratory equipment to the first fluid handling module 104 and the third fluid handling module 112. Once all of the cradles, modules, and laboratory equipment are coupled to the deck 128, the user can prompt the UI 918 to start the lab work process. Prior to starting the lab work process, the redundant device can perform a verification that all cradles, modules, and laboratory equipment are coupled to the deck 128.

The liquid handling system 900 may further include liquid handling system hardware 920. The liquid handling system hardware 920 may include, for example, a movable stage and a plurality of pipettes, a deck, cradles coupled to the deck, and any type of modules that may be coupled to the cradles and used to process the liquids dispensed by the liquid handling system 900. The modules that may be coupled to the cradles and used to process the liquids dispensed by the liquid handling system 900 may include, for example, a temperature deck, a heat shaker, a thermocycler, a heating device, a cooling device, a vacuum pump, a centrifuge, a liquid handler, a tube handling device, a sealing device, an unsealing device, a magnetic device, other modules, and combinations thereof. Further, the liquid handling system hardware 920 may include a housing of the liquid handling system 900 and any other elements of the liquid handling system 900.

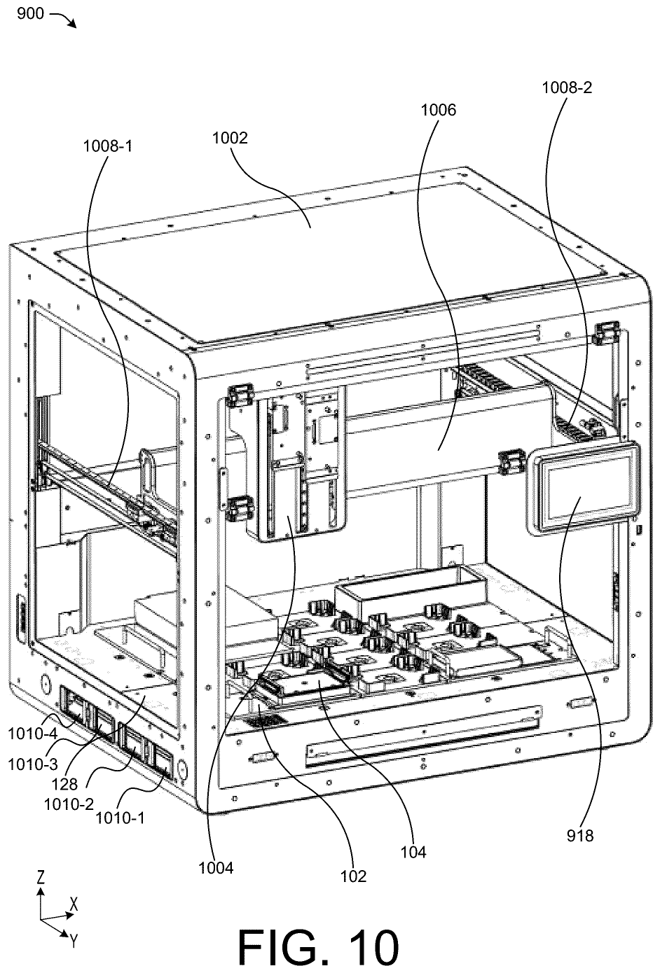

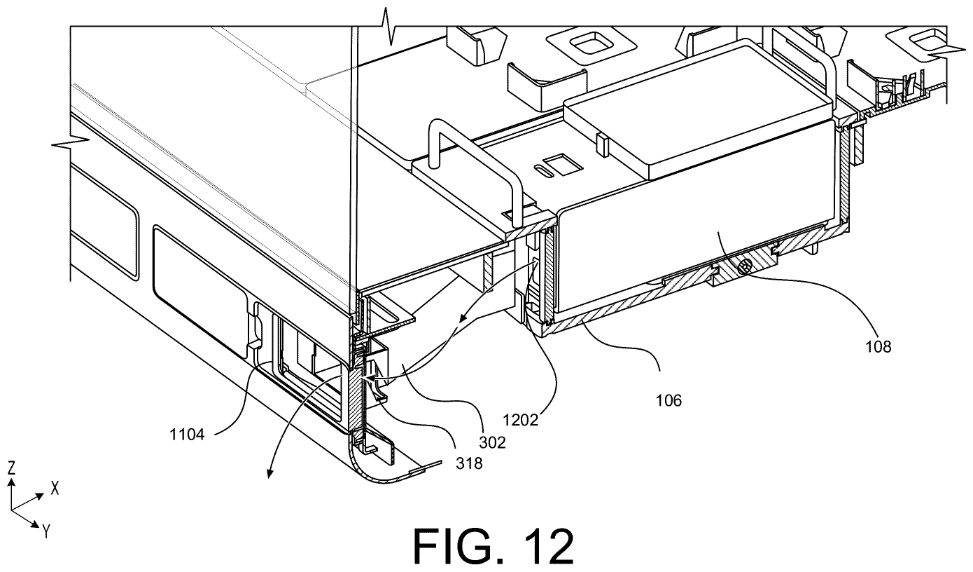

FIG. 10 illustrates the liquid handling system 900 of FIG. 9, according to an example of the principles described herein. As mentioned above, the liquid handling system 900 may further include liquid handling system hardware 920. Some of those elements of the liquid handling system hardware 920 are depicted in FIG. 12. For example, the liquid handling system 900 may include a housing 1002. The housing 1002 may include one or more sides or walls, and, as illustrated in FIG. 12, the housing 1002 may include a top side, four vertically positioned side walls, and a bottom side coupled to one another to form a generally box-like architecture to house and accommodate for a number of other liquid handling system hardware 920. In one example, one or more of the top side, the side walls, and the bottom side may include a transparent portion such as windows to allow for a user to view into the internal portion of the housing 1002.

Housed within the housing 1002 may be the movable stage 1004. The movable stage 1004 may be mechanically coupled to an x-axis movable truss 1006 that may cause the movable stage 1004 to move in the x-direction. Further, the movable stage 1004 may be mechanically coupled to a first y-axis movable truss 1008-1 and a second y-axis movable truss 1008-2 that may cause the movable stage 1004 in the y-direction. The x-axis movable truss 1006 and the first y-axis movable truss 1008-1 and the second y-axis movable truss 1008-2 may be driven by one or more motors that may be actuated through instructions received from the instructing device 928 and any of the elements within the baseboard 902. The instructions used to actuate the motors may cause the movable stage 1004 to be moved to a digitally addressable location within the interior of the housing 1002.

The housing 1002 may also house the deck 128. The deck 128 may be positioned at the bottom of the housing 1002 and may retain one or more cradle devices such as the first cradle 102. The first cradle 102 may be removably or selectively coupled to the deck 128 and may be used to retain a module such the first fluid handling module 104 that may be coupled to the first cradle 102 and used to process liquids dispensed by the liquid handling system 900. As describe in association with FIG. 9, the first fluid handling module 104 may include, for example, a temperature deck, a heat shaker, a thermocycler, a heating device, a cooling device, a vacuum pump, a centrifuge, a liquid handler, a tube handling device, a sealing device, an unsealing device, a magnetic device, other modules, and combinations thereof. In connection with the instructions used to actuate the motors associated with the x-axis movable truss 1006 and the first y-axis movable truss 1008-1 and the second y-axis movable truss 1008-2, these instructions may cause the movable stage 1004 to be moved to a digitally addressable location within the interior of the housing 1002 including an area or portion of or a position on the first fluid handling module 104 such that one or more pipettes may dispense fluids onto or into the first fluid handling module 104.

As illustrated in FIG. 10, the liquid handling system 900 may further include the UI 918. In one example and as illustrated in FIG. 10, the UI 918 may be a touchscreen that is configured to detect touch input from a user and includes both an input device (a touch panel) and an output device (a visual display) where the touch panel is layered on the top of the visual display. The instructions and prompts described in association with FIG. 9 may be presented to the user of the liquid handling system 900 via this or another UI 918. The UI 918 may be communicatively coupled to the instructing device 928 and/or any of the elements within the baseboard 902. This allows the instructing device 928 and/or any of the elements within the baseboard 902 to present the instructions and prompts described herein via the UI 918 and to allow a user to enter information via interactive elements of the UI 918. Although depicted and described as a touchscreen, the UI 918 may include any input and output devices such as, for example, a display device, a printer, an audio speaker, a haptic device, a heads-up display, a keyboard, a mouse, a touchpad, a trackpad, an accelerometer, a gyroscope, a proximity sensor, a thermometer, a virtual reality system, an augmented reality system, a joystick, a gamepad, a paddle, a camera, a microphone, other input and/or output devices, and combinations thereof. Furthermore, although depicted and described as being physically and/or electrically coupled to the liquid handling system 900, the UI 918 may be associated with (e.g., mechanically or electrically coupled to) a remote device (e.g., a remote computing device) that is communicatively coupled to the liquid handling system 900 via the network 930, and a user may interact with the UI 918 at the remote device to operate the liquid handling system 900.

As illustrated in FIG. 10, the liquid handling system 900 may further include openings positioned proximate a at least a bottom of a side wall of the housing 1002. In one example and as illustrated in FIG. 10, the housing 1002 may include a first opening 1010-1, a second opening 1010-2, a third opening 1010-3, and a fourth opening 1010-4. The housing 1002 may include openings at the side wall opposite the first opening 1010-1. The openings 1010-1 through 1010-4 may be used to allow heated air generated by modules to pass through. The openings 1010-1 through 1010-4 may also be used to allow electric cables or wires that power the modules to pass through. For example, the duct 702 may be positioned proximate the openings 1010-3 and 1010-4 such that heat generated by the third fluid handling module 112 (e.g., the thermocycler) may pass through the duct 702 and the openings 1010-3 and 1010-4 to outside the liquid handling system 900 and/or beyond the scope of the deck 128, and thus making sure that the temperature underneath the deck 128 and the temperature at and/or above the deck 128 are unaffected by the use of the third fluid handling module 112. The third fluid handling module 112 and/or the third cradle 110 may further include temperature sensor(s) configured to measure the temperature at and/or above the deck 128 and/or the temperature underneath the deck 128. The third fluid handling module 112 and/or the third cradle 110 may further be configured to control an flow of the air passing through the third fluid handling module 112 and the opening 1010-3 and 1010-4 to maintain the temperature at and/or above the deck 128 and/or the temperature underneath the deck 128 at or below a threshold temperature or at or below a temperature prior to the operation of the third fluid handling module 112. The openings may further include covers that are configured to close when the openings are not in use.

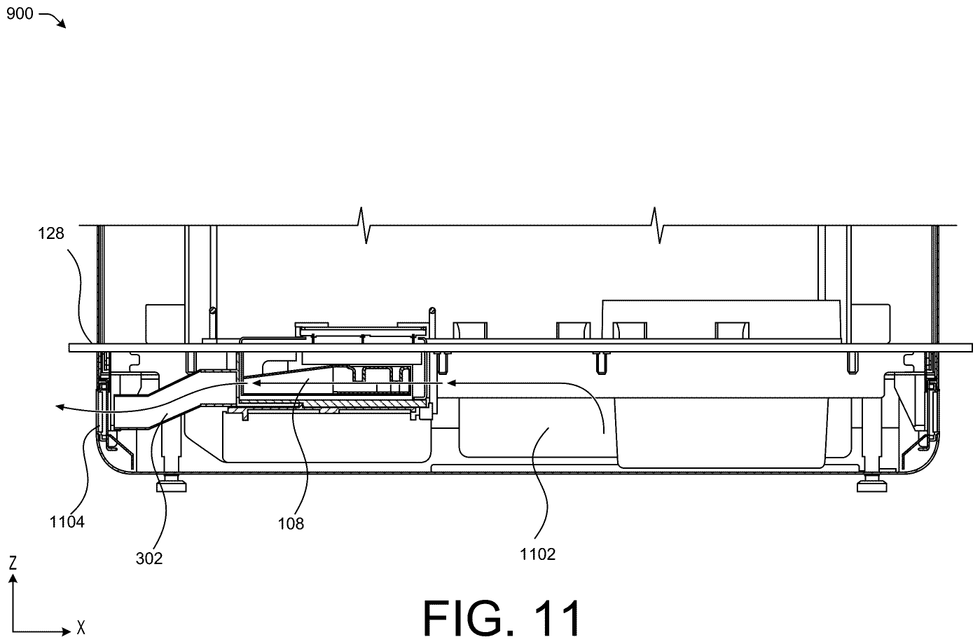

FIG. 11 illustrates a partially cutaway, perspective view of the liquid handling system 900 of FIG. 9. As illustrated in FIG. 11, the liquid handling system 900 can include an air intake component 1102 where outside air can enter the liquid handling system 900. The liquid handling system 900 can direct the outside air towards the second fluid handling module 108. The arrows in FIG. 11 depicts the path that the outside air takes through the liquid handling system 900. The second fluid handling module 108, as illustrated, is the heater shaker. The second fluid handling module 108 may include a first opening that permits the air to pass through from outside the second fluid handling module 108 into an internal chamber. The second fluid handling module 108 may further include a second opening that permits the air to pass from the internal chamber to the duct 302. As the air passes through the internal chamber, the second fluid handling module 108 may heat the air to a higher temperature. The heated air may be removed from the second fluid handling module 108 through the duct 302 and to the outside via the opening 1104, thereby allowing the second fluid handling module 108 to maintain its temperature and prevent overheating, allowing the air to pass beyond the scope of the deck 128, and making sure that the temperature underneath the deck 128 and/or the temperature at and/or above the deck 128 are not affected by the use of the second fluid handling module 108. The second fluid handling module 108 or the second cradle 106 may further include temperature sensor(s) configured to measure the temperature at and/or above the deck 128 and/or the temperature underneath the deck 128. The second fluid handling module 108 or the second cradle 106 may further be configured to control an flow of the air passing through the internal chamber and the opening(s) 1010-1 through 1010-4 to maintain the temperature at and/or above the deck 128 and/or the temperature underneath the deck 128 at or below a threshold temperature or at or below a temperature prior to the operation of the second fluid handling module 108.

FIG. 12 illustrates an alternative partially cutaway, perspective view of the liquid handling system 900 of FIG. 9. As illustrated in FIG. 12, the second cradle 106 includes an opening 1202. The opening 1202 may permit an electric wire or cable to connect to the second fluid handling module 108. The electric wire or cable may be first routed through both the opening 1202 and the slot 318, which allows the electric wire or cable to be routed through the liquid handling system 900 in a neat and efficient fashion such that the electric wire or cable does not interfere with the liquid handling system 900 while the liquid handling system 900 is operating a protocol. Alternatively, the electric wire or cable may be routed internally and to the outside of the liquid handling system 900 through a bottom of the deck 128. The electric wire or cable may electrically connect to the second fluid handling module 108 to a power source. The power source may be an external power source or at the liquid handling system 900, thereby the electric wire or cable may be physically and electrically coupled to the liquid handling system 900, a remote computing device coupled to the liquid handling system 900, a remote computing device separate from the liquid handling system 900, and/or the external power source. In one example, the electric wire or cable may connect to a port on the liquid handling system 900 that is configured to provide power to the second fluid handling module 108. As illustrated by the arrows, the electric wire or cable may pass through the slot 318 and through the opening 1104.

FIG. 13 illustrates a perspective view of an alternative configuration for the deck assembly of FIG. 1. FIG. 13, as illustrated, includes the deck 128, the large slot covers 120, the small slot covers 124, the extra slot cover 212, the first leg 202-1, the second leg 202-2, the third leg 202-3, the first expansion cover 1302-1, the second expansion cover 1302-2, the third expansion cover 1302-3, and the fourth expansion cover 1302-4.

Each of the expansion covers 1302-1 through 1302-4 (also collectively referred to as the expansion covers 1302), as illustrated, may be configured to replace one of the large slot covers 120 and may be longer longitudinally than the large slot covers 120. In this configuration, each expansion cover 1302-1 through 1302-4 may include a first slot cover that corresponds in position and size to the large cover receptacles 122 of FIG. 1 and an expansion cover receptacle of the expansion cover receptacles 1304-1, 1304-2, 130-4-3, and 1304-4 (also collectively referred to as the expansion cover receptacles 1304) positioned proximate the first slot cover. Each expansion cover receptacle 1304-1 through 1304-4 may be sized similarly as the large cover receptacles 122 and may be configured to perform the same function as the large cover receptacles 122. In this configuration, as illustrated, the first expansion cover 1302-1 may be coupled to and/or positioned at the deck slots D3 and D4 as illustrated in the legend 136 of FIG. 1, the second expansion cover 1302-2 may be coupled to and/or positioned at the deck slots C3 and C4 as illustrated in the legend 136 of FIG. 1, the third expansion cover 1302-3 may be coupled to and/or positioned at the deck slots B3 and B4 as illustrated in the legend 136 of FIG. 1, and the fourth expansion cover 1302-4 may be coupled to and/or positioned at the deck slots A3 and A4 as illustrated in the legend 136 of FIG. 1.

Alternatively, each expansion cover 1302-1 through 1302-4 may be a smaller sized cover that may be configured to couple to the large slot covers 120. The size of such expansion slot cover may correspond to the size of the small slot covers 124. The expansion covers 1302 may be coupled to a top of the large slot covers 120 and/or the deck 128 using fastener(s) (e.g., screw(s), magnet(s), and/or the like). In this configuration, as illustrated, the first expansion cover 1302-1 may be positioned at the position of the deck slot D4 of the legend 136 of FIG. 1, the second expansion cover 1302-2 may be positioned at the deck slot C4 of the legend 136 of FIG. 1, the third expansion cover 1302-3 may be positioned at the deck slot B4 of the legend 136 of FIG. 1, and the fourth expansion cover 1302-4 may be positioned at the deck slot A4 of the legend 136 of FIG. 1.

In either of the above configurations of the expansion covers 1302, the expansion cover receptacles 1304 may be accessible by the robotic arms and/or gripper arms of the liquid handling system 900 and may be inaccessible by the pipette(s) of the liquid handling system 900. Further, the position of the expansion cover receptacles 1304 may not be calibrated for and/or by the liquid handling system 900. Alternatively, the expansion cover receptacles 1304 may be accessible by both the robotic arms and/or gripper arms and the pipette(s) and its position(s) may be calibrated by and/or for the liquid handling system 900.

While FIG. 13 illustrates the expansion covers 1302 covering all of the deck slots along one longitudinal end of the deck 128, it is contemplated that the expansion covers 1302 may be used to cover one or more of any of the deck slots that the large slot covers 120 can be coupled to.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

### Example Clauses

A: A deck for a fluid handling system comprising: a first deck slot defined in the deck, the first deck slot comprising a first mounting aperture positioned proximate a first longitudinal end of the first deck slot; a second deck slot defined in the deck, the second deck slot comprising a second mounting aperture positioned proximate a second longitudinal end of the second deck slot; and a first cradle configured to removably couple to a first fluid handling module of a first type and configured to removably couple to the first deck slot via the first mounting aperture or the second deck slot via the second mounting aperture.
B: The deck according to paragraph A, further comprising: a third mounting aperture positioned proximate a third longitudinal end of the first deck slot opposite the first longitudinal end; and a fourth mounting aperture positioned proximate a fourth longitudinal end of the second deck slot opposite the second longitudinal end, wherein the first cradle is further configured to removably couple to the first deck slot via the first mounting aperture and the third mounting aperture or the second deck slot via the second mounting aperture and the fourth mounting aperture.
C: The deck according to paragraph B, further comprising: a first mounting header; a first header fastener; a first mounting base removably coupled to the first mounting header via the first header fastener to securely couple the first longitudinal end of the first cradle to the first deck slot or the second deck slot; a second mounting header; a second header fastener; a second mounting base removably coupled to the second mounting header via the first header fastener to securely couple the second longitudinal end of the first cradle to the first deck slot or the second deck slot, wherein securely coupling the first cradle to the first deck slot or the second deck slot comprises: coupling the first cradle to the first deck slot or the second deck slot; inserting the first header fastener through the first mounting aperture or the third mounting aperture; coupling the first mounting header and the first mounting base to the first header fastener; inserting the second header fastener through the second mounting aperture or the fourth mounting aperture; and coupling the second mounting header and the second mounting base to the second header fastener.
D: The deck according to any of paragraphs A-C, wherein the first mounting aperture comprises a first threaded aperture; and the second mounting aperture comprises a second threaded aperture.
E: The deck according to any of paragraphs A-D, wherein the first fluid handling module comprises: a temperature deck; a heat shaker; a thermocycler; a heating device; a cooling device; a vacuum pump; a centrifuge; a liquid handler; a tube handling device; a sealing device; an unsealing device; or a magnetic device.
F: The deck according to any of paragraphs A-E, wherein the first cradle comprises at least one of: an air duct; a button; a clamp; or a handle.
G: The deck according to paragraph F, wherein the first cradle comprises the air duct, the air duct configured to permit heat produced by the first fluid handling module to pass through to an outside of the first cradle and the first fluid handling module.
H: The deck according to any of paragraphs F-G, wherein the first cradle comprises the button and the first cradle is electrically or mechanically coupled to the first fluid handling module such that when the button is depressed, a function of the first fluid handling module is activated or deactivated.
I: The deck according to any of paragraphs F-H, wherein the first cradle comprises the clamp, the clamp is configured to securely couple the first fluid handling module to the first cradle.
J: The deck according to any of paragraphs A-I, wherein the first cradle is coupled to the first deck slot, the deck further comprises a second cradle coupled to the second deck slot, the second cradle configured to be coupled to a second fluid handling module of a second type, the second type being different from the first type.
K: The deck according to any of paragraphs A-J, further comprising a slot cover configured to be removably coupled to the first deck slot or the second deck slot, the slot cover comprising a receptacle configured to receive: a microplate; a well reservoir; or a test tube rack.
L: A fluid handling system comprising: a deck comprising: a first deck slot; and a second deck slot; a first cradle configured to be removably coupled to the first deck slot or the second deck slot; and a first fluid handling module of a first type configured to be removably coupled to the first cradle.
M: The fluid handling system according to paragraph L, further comprising: a display device; a processor communicatively coupled to the display device; and a non-transitory computer-readable media storing instructions that, when executed by the processor, causes the processor to perform operations comprising: presenting instruction on the display device, the instruction presenting at least one step used to couple the first fluid handling module to the first cradle and one step used to couple the first cradle to the first deck slot or the second deck slot.
N: The fluid handling system according to paragraph M, the operations further comprising: determining to couple the first cradle to the first deck slot; detecting, in response to determining to couple the first cradle to the first deck slot and using a sensor, whether a slot cover is coupled to the first deck slot; and presenting, in response to detecting the slot cover being coupled to the first deck slot, second instruction on the display device, the second instruction presenting at least one step of removing the slot cover from the first deck slot.
O: The fluid handling system according to any of paragraphs L-N, wherein the first deck slot comprises a first mounting aperture positioned proximate a first longitudinal end of the first deck slot and a second mounting aperture positioned proximate a second longitudinal end of the first deck slot opposite the first longitudinal end; and wherein the first cradle is configured to removably couple to the first deck slot via the first mounting aperture and the second mounting aperture.
P: The fluid handling system according to paragraph O, further comprising: a first mounting header; a first header fastener; a first mounting base removably coupled to the first mounting header via the first header fastener to securely couple the first longitudinal end of the first cradle to the first deck slot; a second mounting header; a second header fastener; a second mounting base removably coupled to the second mounting header via the first header fastener to securely couple the second longitudinal end of the first cradle to the first deck slot, wherein securely coupling the first cradle to the first deck slot comprises: coupling the first cradle to the first deck slot; inserting the first header fastener through the first mounting aperture; coupling the first mounting header and the first mounting base to the first header fastener; inserting the second header fastener through the second mounting aperture; and coupling the second mounting header and the second mounting base to the second header fastener.
Q: The fluid handling system according to any of paragraphs O-P, wherein the first cradle is coupled to the first deck slot, the deck further comprises a second cradle coupled to the second deck slot, the second cradle configured to be coupled to a second fluid handling module of a second type, the second type being different from the first type.
R: The fluid handling system according to any of paragraphs L-Q, wherein the first fluid handling module or the first cradle is further configured to control a first temperature above the deck or a second temperature below the deck.
S: The fluid handling system according to paragraph R, further comprising a housing, the housing comprising an aperture positioned proximate and below a first longitudinal end of the first deck slot, wherein the first fluid handling module is configured to control the first temperature or the second temperature by passing air heated the first fluid handling module to an outside of the fluid handling system through the aperture.
T: The fluid handling system according to paragraph S, wherein the aperture is further configured to permit a cable to pass through and electrically or mechanically connect to the first fluid handling module.
U: A method, comprising: receiving, by a fluid handling system, a command to begin a laboratory process; receiving, by the fluid handling system, sensor data; determining, in response to the command and based on the sensor data, whether a cradle is coupled to a deck slot; presenting, in response to determining that the deck slot does not include the cradle, instruction on a display device associated with the fluid handling system, the instruction presenting at least one step of coupling the cradle to the deck slot; and executing, by the fluid handling system and in response to the cradle being coupled to the deck slot, the laboratory process.
V: The method according to paragraph U, further comprising: determining, based on the sensor data, whether a slot cover is coupled to the deck slot; and presenting, in response to determining that the slot cover is coupled to the deck slot, second instruction on the display device, the second instruction presenting at least one step of removing the slot cover from the deck slot.
W: The method according to paragraph V, wherein removing the slot cover comprises: removing a first fastener from a first mounting aperture positioned proximate a first longitudinal end of the deck slot; and removing a second fastener from a second mounting aperture positioned proximate a second longitudinal end of the deck slot opposite the first longitudinal end.
X: The method according to any of paragraphs U-W, further comprising: determining whether a fluid handling module is coupled to the cradle; and presenting, in response to determining that the cradle does not include the fluid handling module, third instruction on the display device, the third instruction presenting at least one step of coupling the fluid handling module to the cradle.

### CONCLUSION

The examples described herein provide a liquid handling system that includes a means by which a user may easily couple different liquid handling modules configured to perform different liquid handling functions to a deck of the liquid handling system without the requirement of a specialized operator, a service provider, or a technician.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure, and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A deck for a fluid handling system comprising:
a first deck slot defined in the deck, the first deck slot comprising a first mounting aperture positioned proximate a first longitudinal end of the first deck slot;
a second deck slot defined in the deck, the second deck slot comprising a second mounting aperture positioned proximate a second longitudinal end of the second deck slot; and
a first cradle configured to removably couple to a first fluid handling module of a first type and configured to removably couple to the first deck slot via the first mounting aperture or the second deck slot via the second mounting aperture.

2. The deck of claim 1, further comprising:
a third mounting aperture positioned proximate a third longitudinal end of the first deck slot opposite the first longitudinal end; and
a fourth mounting aperture positioned proximate a fourth longitudinal end of the second deck slot opposite the second longitudinal end,
wherein the first cradle is further configured to removably couple to the first deck slot via the first mounting aperture and the third mounting aperture or the second deck slot via the second mounting aperture and the fourth mounting aperture.

3. The deck of claim 2, further comprising:
a first mounting header;
a first header fastener;
a first mounting base removably coupled to the first mounting header via the first header fastener to securely couple the first longitudinal end of the first cradle to the first deck slot or the second deck slot;
a second mounting header;
a second header fastener;
a second mounting base removably coupled to the second mounting header via the first header fastener to securely couple the second longitudinal end of the first cradle to the first deck slot or the second deck slot, wherein securely coupling the first cradle to the first deck slot or the second deck slot comprises:
coupling the first cradle to the first deck slot or the second deck slot;
inserting the first header fastener through the first mounting aperture or the third mounting aperture;
coupling the first mounting header and the first mounting base to the first header fastener;
inserting the second header fastener through the second mounting aperture or the fourth mounting aperture; and
coupling the second mounting header and the second mounting base to the second header fastener.

4. The deck of claim 1, wherein the first mounting aperture comprises a first threaded aperture; and
the second mounting aperture comprises a second threaded aperture.

5. The deck of claim 1, wherein the first fluid handling module comprises:
a temperature deck;
a heat shaker,
a thermocycler;
a heating device;
a cooling device;
a vacuum pump;
a centrifuge;
a liquid handler,
a tube handling device;
a scaling device;
an unscaling device; or
a magnetic device.

6. The deck of claim 1, wherein the first cradle comprises at least one of:
an air duct;
a button;
a clamp; or
a handle.

7. The deck of claim 6, wherein the first cradle comprises the air duct, the air duct configured to permit heat produced by the first fluid handling module to pass through to an outside of the first cradle and the first fluid handling module.

8. The deck of claim 6, wherein the first cradle comprises the button and the first cradle is electrically or mechanically coupled to the first fluid handling module such that when the button is depressed, a function of the first fluid handling module is activated or deactivated.

9. The deck of claim 6, wherein the first cradle comprises the clamp, the clamp is configured to securely couple the first fluid handling module to the first cradle.

10. The deck of claim 1, wherein the first cradle is coupled to the first deck slot, the deck further comprises a second cradle coupled to the second deck slot, the second cradle configured to be coupled to a second fluid handling module of a second type, the second type being different from the first type.

11. The deck of claim 1, further comprising a slot cover configured to be removably coupled to the first deck slot or the second deck slot, the slot cover comprising a receptacle configured to receive:
a microplate;
a well reservoir; or
a test tube rack.

12. A fluid handling system comprising:
a deck comprising:
a first deck slot; and
a second deck slot;
a first cradle configured to be removably coupled to the first deck slot or the second deck slot; and
a first fluid handling module of a first type configured to be removably coupled to the first cradle.

13. The fluid handling system of claim 12, further comprising:
a display device;
a processor communicatively coupled to the display device; and
a non-transitory computer-readable media storing instructions that, when executed by the processor, causes the processor to perform operations comprising:
presenting instruction on the display device, the instruction presenting at least one step used to couple the first fluid handling module to the first cradle and one step used to couple the first cradle to the first deck slot or the second deck slot.

14. The fluid handling system of claim 13, the operations further comprising:
determining to couple the first cradle to the first deck slot;
detecting, in response to determining to couple the first cradle to the first deck slot and using a sensor, whether a slot cover is coupled to the first deck slot; and
presenting, in response to detecting the slot cover being coupled to the first deck slot, second instruction on the display device, the second instruction presenting at least one step of removing the slot cover from the first deck slot.

15. The fluid handling system of claim 12, wherein the first deck slot comprises a first mounting aperture positioned proximate a first longitudinal end of the first deck slot and a second mounting aperture positioned proximate a second longitudinal end of the first deck slot opposite the first longitudinal end; and
wherein the first cradle is configured to removably couple to the first deck slot via the first mounting aperture and the second mounting aperture.

16. The fluid handling system of claim 15, further comprising:
a first mounting header;
a first header fastener;
a first mounting base removably coupled to the first mounting header via the first header fastener to securely couple the first longitudinal end of the first cradle to the first deck slot;
a second mounting header;
a second header fastener;
a second mounting base removably coupled to the second mounting header via the first header fastener to securely couple the second longitudinal end of the first cradle to the first deck slot, wherein securely coupling the first cradle to the first deck slot comprises:
coupling the first cradle to the first deck slot;
inserting the first header fastener through the first mounting aperture;
coupling the first mounting header and the first mounting base to the first header fastener;
inserting the second header fastener through the second mounting aperture; and
coupling the second mounting header and the second mounting base to the second header fastener.

17. The fluid handling system of claim 15, wherein the first cradle is coupled to the first deck slot, the deck further comprises a second cradle coupled to the second deck slot, the second cradle configured to be coupled to a second fluid handling module of a second type, the second type being different from the first type.

18. The fluid handling system of claim 12, wherein the first fluid handling module or the first cradle is further configured to control a first temperature above the deck or a second temperature below the deck.

19. The fluid handling system of claim 18, further comprising a housing, the housing comprising an aperture positioned proximate and below a first longitudinal end of the first deck slot,
wherein the first fluid handling module is configured to control the first temperature or the second temperature by passing air heated the first fluid handling module to an outside of the fluid handling system through the aperture.

20. The fluid handling system of claim 19, wherein the aperture is further configured to permit a cable to pass through and electrically or mechanically connect to the first fluid handling module.

21. A method, comprising:
receiving, by a fluid handling system, a command to begin a laboratory process;
receiving, by the fluid handling system, sensor data;
determining, in response to the command and based on the sensor data, whether a cradle is coupled to a deck slot;
presenting, in response to determining that the deck slot does not include the cradle, instruction on a display device associated with the fluid handling system, the instruction presenting at least one step of coupling the cradle to the deck slot; and
executing, by the fluid handling system and in response to the cradle being coupled to the deck slot, the laboratory process.

22. The method of claim 21, further comprising:
determining, based on the sensor data, whether a slot cover is coupled to the deck slot; and
presenting, in response to determining that the slot cover is coupled to the deck slot, second instruction on the display device, the second instruction presenting at least one step of removing the slot cover from the deck slot.

23. The method of claim 22, wherein removing the slot cover comprises:
removing a first fastener from a first mounting aperture positioned proximate a first longitudinal end of the deck slot; and
removing a second fastener from a second mounting aperture positioned proximate a second longitudinal end of the deck slot opposite the first longitudinal end.

24. The method of claim 21, further comprising:
determining whether a fluid handling module is coupled to the cradle; and
presenting, in response to determining that the cradle does not include the fluid handling module, third instruction on the display device, the third instruction presenting at least one step of coupling the fluid handling module to the cradle.
